(19) United States
(12) Patent Application Publication
(10) Pub. No.: US 2003/0222005 A1
(43) Pub. Date: Dec. 4, 2003

(54) Apparatus and methods for reducing contaminants in water systems using information distribution

(76) Inventors: Paul Polizzotto, Hermosa Beach, CA (US); Steven M. Ehlinger II, Redondo Beach, CA (US); Thomas A. Ellrott, Harbor City, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/339,795

(22) Filed: Jan. 9, 2003

Related U.S. Application Data
(60) Provisional application No. 60/347,159, filed on Jan. 9, 2002.

(51) Int. Cl. B01D 21/30

(52) U.S. Cl. 210/143

(57) ABSTRACT

The present invention relates to apparatus and methods for reducing water runoff pollution. Non-tax funding is obtained from a non-governmental entity for at least a portion of a water runoff pollution abatement program. Authorization is received from a local governmental body for the display of at least a first advertisement related to the water runoff pollution abatement program on at least a first property. At least a portion of the funding is provided to the local government body for implementation of the water runoff pollution abatement program, wherein the water runoff pollution abatement program is at least partly under the control of the local governmental body.

### RELATED APPLICATION

This application is related to copending application entitled MAPPING AND POLLUTION INFORMATION SITE SELECTION APPARATUS AND METHODS, Ser. No. [Unknown] [Attorney Docket No. ECC.002A], filed on the same date as the present application, the entirety of which is hereby incorporated by reference.

### PRIORITY CLAIM

This application claims the benefit under 35 U.S.C. 119(e) of U.S. Provisional Application No. 60/347,159, filed Jan. 9, 2002, the content of which is incorporated herein in its entirety.

### COPYRIGHT RIGHTS

A portion of the disclosure of this patent document contains material that is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### BACKGROUND OF THE INVENTION

1. Field of the Invention

The present invention is related to pollution control, and in particular, to apparatus and methods for reducing water runoff pollution via information distribution.

2. Description of the Related Art

As illustrated in FIG. 1, unlike sewage, which can originate as household waste water 108 and which flows via a sewer pipe 102 to a sewage treatment facility, urban storm water runoff from storm drains 104 is seldom treated before it's discharged via a storm drain tunnel 106 or the like into a waterway, such as into a lake, ocean, river, stream, bay, wetland, or the like. Polluted runoff can result in the destruction of fish, wildlife, and aquatic life habitats. Polluted runoff can threaten public health if the pollution contaminates drinking water supplies, food, and swimming areas.

The Clean Water Act governs pollution control and water quality of the United States's waterways. An objective of this Act is to restore and maintain the chemical, physical and biological integrity of the country's waters. The Clean Water Act establishes a national goal that waters of the U.S. should be fishable and swimmable, wherein the goal is to be achieved by eliminating pollutant discharges into waters of the U.S. The Clean Water Act regulates discharges to waters of the United States through permits issued under the National Pollutant Discharge Elimination System (NPDES) permitting program. The Water Quality Protection Division issues the NPDES permits and the Water Enforcement Branch assures that discharges comply with the NPDES permits.

However, despite the goals and mandates of the Clean Water Act, urban and storm water runoff pollution has actually increased in many areas. According to the U.S. Environmental Protection Agency (EPA), 40 percent of the nation's waterways are too polluted for swimming and fishing, and they fail to meet even minimum water quality standards to protect human health and wildlife. Some examples of these impaired waterways include 291,000 miles of rivers and streams; nearly half the nation's lakes, reservoirs, and ponds; and 96 percent of the shoreline miles of the Great Lakes. In addition, wetlands are being lost in the contiguous U.S. at a rate of about 100,000 acres a year.

In an attempt to better control pollution, such as storm runoff pollution, the Environmental Protection Agency has issued the Storm Water Phase II rule which generally mandates operators of small Municipal Separate Storm Sewer Systems (MS4s) in urbanized areas to develop and implement a storm water management program which addresses six minimum control measures. Some of these rules emphasize prevention of pollutants from ever getting into storm water, as well as construction site storm water runoff control. In particular, the rules relate to public education and outreach on storm water impacts, public involvement/participation, illicit discharge detection and elimination, construction site storm water runoff control, post-construction storm water management in new development and redevelopment, and pollution prevention/good housekeeping for municipal operations.

However, due to the complexity and expense of complying, many municipalities and states have failed to comply with many of the rules and have failed to adequately control storm runoff pollution. Noncompliance can result in severe financial and other penalties. Federal laws provide EPA and authorized state regulatory agencies with various methods of taking enforcement actions against violators of NPDES permit requirements. For example, EPA and state regulatory agencies may issue administrative orders that require facilities to correct violations and that assess monetary penalties.

The law also allows EPA and state regulatory agencies to pursue civil and criminal actions that may include mandatory injunctions or penalties, as well as jail sentences for persons found willfully violating requirements and endangering the health and welfare of the public or environment.

### SUMMARY OF THE INVENTION

The present invention relates to apparatus and methods for reducing water runoff pollution. Further, one embodiment enables governmental entities to better comply and track compliance with governmental statutes, regulations, mandates, and/or goals.

Embodiments of the present invention facilitate the provisioning of educational materials while also facilitating the funding of pollution abatement, thereby helping governments comply with some or all of the EPA's six minimum control measures. Further, certain embodiments facilitate the auditing of participating governmental entities to better ensure the funds and educational materials are used for an urban and storm water runoff abatement program.

Additionally, certain embodiments enable local businesses and national corporations to benefit from advertising and promotional opportunities in their communities of interest as sponsors of efforts to abate pollution. Further, embodiments facilitate the designing, installing, and maintaining an inventory of beneficial outdoor and roadside advertising signs created through the sponsorship of specific local government bodies' urban and storm water runoff abatement programs. In design and in message, the signs are educational and optionally reflect the geographic area and the body of water in the area where they are to be installed. Advantageously, certain embodiments help local and other governments avoid fines and other penalties for failure to meet NPDES permit requirements.

One embodiment is a method of distributing pollution related information by a first non-governmental entity, comprising: identifying a local government body that is to adhere to a water runoff pollution abatement program, including a pollution-related public educational element, wherein the local government body has the authority to allow the display of an advertisement on at least a portion of property under its control; obtaining funding from a second non-governmental entity for at least a portion of the water runoff pollution abatement program; receiving authorization from the local governmental body for the first non-governmental entity to provide at least a first advertisement containing both pollution-related educational information and identification information corresponding to the second non-governmental entity on at least a first property under local governmental body's control; and providing at least a portion of the funding to the local government body to be utilized in connection with implementation of the water runoff pollution abatement program under the control of the local governmental body.

Another embodiment is a method of distributing pollution related information, comprising: obtaining non-tax funding from a non-governmental entity for at least a portion of a water runoff pollution abatement program; receiving authorization from a local governmental body for the display of at least a first advertisement related to the water runoff pollution abatement program on at least a first property; and providing at least a portion of the funding to the local government body for implementation of the water runoff pollution abatement program, wherein the water runoff pollution abatement program is at least partly under the control of the local governmental body.

Still another embodiment is a method of distributing pollution related information, comprising: identifying a governmental entity subject to a pollution reduction program; obtaining voluntary funding from a non-governmental sponsor for at least a portion of the pollution reduction program; arranging with the governmental entity for the display of at least a first advertisement on at least a first property under at least partial control of the governmental entity, the first advertisement related to the pollution reduction program; and arranging for at least a portion of the funding to be provided to the local government body for implementation of the pollution reduction program under the control of the governmental entity.

One embodiment is a sign, comprising: an image of at least one body of water; one or more of a sign sponsor name and logo; and information on water pollution abatement.

### BRIEF DESCRIPTION OF THE DRAWINGS

Embodiments of the present invention will now be described with reference to the drawings summarized below. These drawings and the associated description are provided to illustrate example embodiments of the invention, and not to limit the scope of the invention.

FIG. 1 illustrates urban sewage and storm water flow;

FIGS. 2A-2B illustrate an example process for pollution-related information distribution;

FIG. 2C illustrates an example data processing system that can be used in accordance with an embodiment of the present invention;

FIG. 3 illustrates an example interaction diagram in accordance with an embodiment of the present invention; and

FIGS. 4A-4B illustrate example signs in accordance with an embodiment of the present invention.

FIGS. 5A-5B illustrate an example brochure.

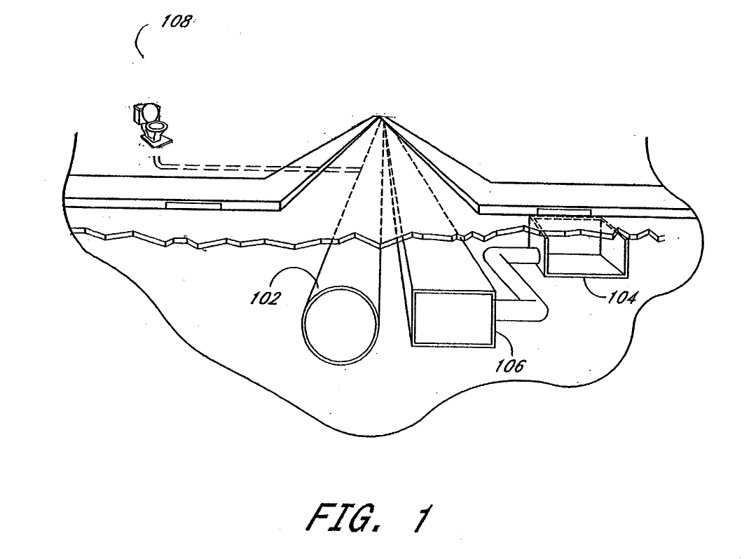

### DETAILED DESCRIPTION OF PREFERRED EMBODIMENTS

The present invention relates to apparatus and methods for reducing water runoff pollution. Further, one embodiment enables governmental entities to better comply and track compliance with governmental statutes and regulations.

Certain embodiments of the present invention efficiently educate the public on the impacts of human actions on the environment through the strategic placement of sponsored outdoor environmental signage using a geographic information system to thereby increase environmental awareness.

While the following description refers to certain statues, regulations, and policies, the present invention is not limited to being used in conjunction with these statues, regulations, and policies, and indeed, embodiments of the present invention can be used without regard to any statues, regulations, or policies. Further, while the following detailed description refers to water pollution, the present invention is not so limited and can be used, for example, in conjunction with other pollution reduction efforts, such as for air or noise pollution reduction efforts.

The regulatory text for the National Pollutant Discharge Elimination System (NPDES) states that “You must implement a public education program to distribute educational materials to the community or conduct equivalent outreach activities about the impacts of storm water discharges on water bodies and the steps that the public can take to reduce pollutants in storm water runoff.”

In addition, the EPA has defined a Storm Water Phase II Menu of Best Management Practices (BMPs). The Phase II rule describes six minimum control measures which most regulated small MS4s will need to implement. The following list of BMPs is based on Phase II's six minimum control measures:

1. Public education and outreach on storm water impacts.

2. Public involvement/participation.

3. Illicit discharge detection and elimination.

4. Construction site storm water runoff control.

5. Post-construction storm water management in new development and redevelopment.

6. Pollution prevention/good housekeeping for municipal operations.

The EPA provides the following guidance:

“You may use storm water educational materials provided by your state; tribe; EPA; environmental, public interest, or trade organizations; or other MS4s. The public education program should inform individuals and households about the steps they can take to reduce storm water pollution, such as ensuring proper septic system maintenance, ensuring the proper use and disposal of landscape and garden chemicals including fertilizers and pesticides, protecting and restoring riparian vegetation, and properly disposing of used motor oil and household hazardous wastes. EPA recommends that the program inform individuals and groups how to become involved in local stream and beach restoration activities, as well as activities that are coordinated by youth service and conservation corps or other citizen groups. EPA recommends that the public education program be tailored, using a mix of locally appropriate strategies, to target specific audiences and communities. Examples of strategies include distributing brochures or fact sheets, sponsoring speaking engagements before community groups, providing public service announcements, implementing educational programs targeted at school age children, and conducting community-based projects such as storm drain stenciling and watershed and beach cleanups. In addition, EPA recommends that some of the materials or outreach programs be directed toward targeted groups of commercial, industrial, and institutional entities likely to have significant storm water impacts. For example, providing information to restaurants on the impact of grease clogging storm drains, and to garages on the impact of oil discharges. You are encouraged to tailor your outreach program to address the viewpoints and concerns of all communities, particularly minority and disadvantaged communities, as well as any special concerns relating to children.”

In one embodiment, an analysis program is used to design and implement at least portions of a regulatory compliance program, such as the Clean Water Act and the National Pollutant Discharge Elimination System (NPDES) permitting requirements. For example, a governmental entity can specify as a goal or as a requirement the number of educational impressions made a year within a given geographical area, municipal area, or other specified physical, governmental, or regulatory area. By way of illustration, the Los Angeles Regional Water Quality Control Board for the City of Los Angeles has set a goal of 35 million impressions per year made on the general public about storm water quality via print, local TV access, local radio, or other appropriate area. Similarly, Orange County has a goal of 10 million impressions per year.

The analysis program utilizes regulatory information, such as the number of required or desired impressions, traffic flow information, permit information, field data, and census information to guide the placement of pollution-related education information. The pollution-related education information can be provided via signs, advertisements, or the like, placed along roadways, waterways, and the like. One embodiment of the present invention includes a database that records selected pollution-related governmental requirements or goals for a given municipality and/or storm sewer system operator. The term database as used herein can include one or more databases or other data stores. The pollution-related governmental requirements include educational requirements, such as the required or desired number of impressions about storm water quality.

In addition, the database stores information related to traffic flow, such as the number of vehicles passing a given point per hour or year, on highways and other thoroughfares in a selected municipal or geographic area associated with the given municipality and/or storm sewer system operator. The database optionally further stores the locations where signage placement is allowed or authorized, at least for pollution-related educational purposes. The database also stores information, such as census information identifying languages spoken by residents in the selected area. The database can be enhanced using the results of a field check of certain information, as discussed below.

The analysis program accesses the database, including the selected pollution-related governmental requirements, signage locations, and the traffic flow information, and provides guidance on where educational information should be placed in order to meet the selected pollution-related governmental requirements. In addition, the analysis program accesses the database and provides guidance on what language the educational information should be in for a plurality of locations.

In particular, signage is preferably installed after socio-cultural geographic research has been conducted on the regional demographic in which a program is to be implemented. The research is conducted through the analysis of textual regional demographic data, cartographic analysis, field checks and and/or through the use of a geographic information system. This allows the appropriate application of region-specific signage evidenced through scientific data and geographic rationale.

For example, the analysis program can identify high traffic corridors that are regularly traveled by the local population as preferred locations for the signage. In addition, the, analysis program can identify locations where traffic slows at major intersections on high traffic corridors. The analysis program can recommend placement of the signage one or two light poles before a given intersection on the right hand side of the road. The strategic placement of the signage creates a captive audience stopped or slowed at the intersection. For example, a single sign can potentially relay 60,000 environmental awareness messages per day. This is a very effective method in relating region-specific environmental messages to local populations.

The database can then store the resulting locations where the educational information was placed, and the educational information languages. The analysis program calculates the estimated viewing impressions for a given time period based on the educational information placement. The calculated estimated viewing impressions are compared to selected pollution-related governmental requirements and a compliance report is generated using a report generator program, which may be part of another program. Thus, the analysis program facilitates the offering of public educational outreach materials, which helps governmental entities, such as local governments, comply with the last two of the EPA's six minimum control measures. That is, public education and outreach on storm water impacts, and public involvement/participation.

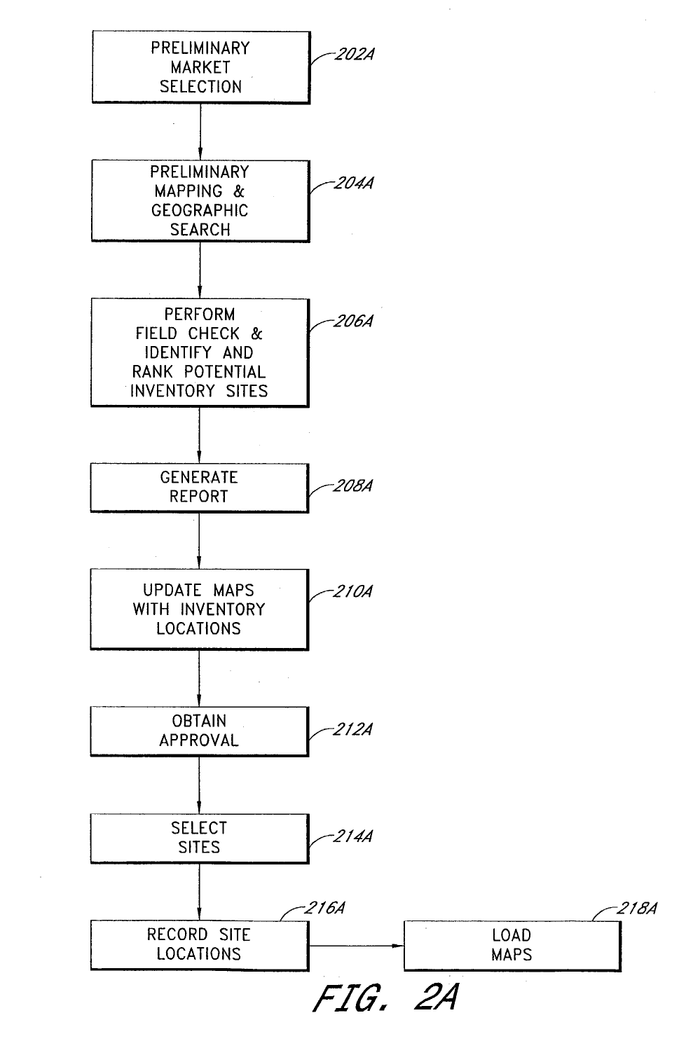

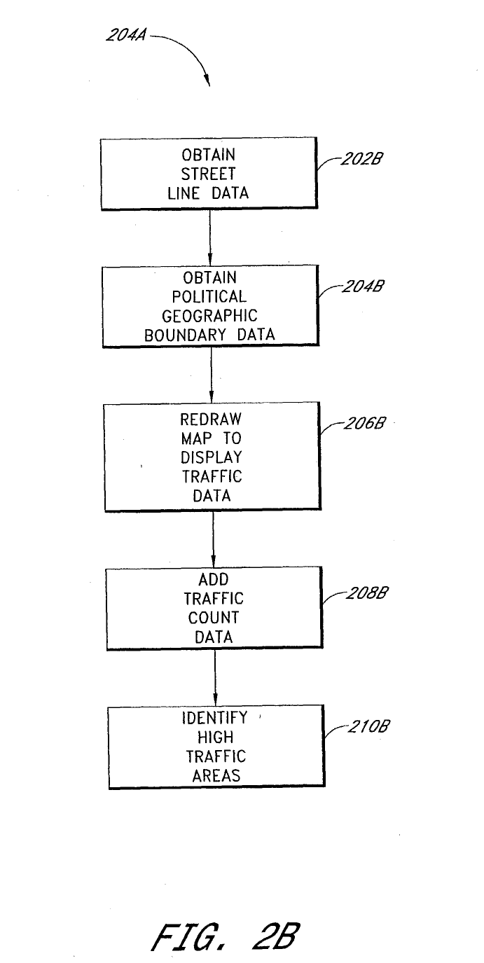

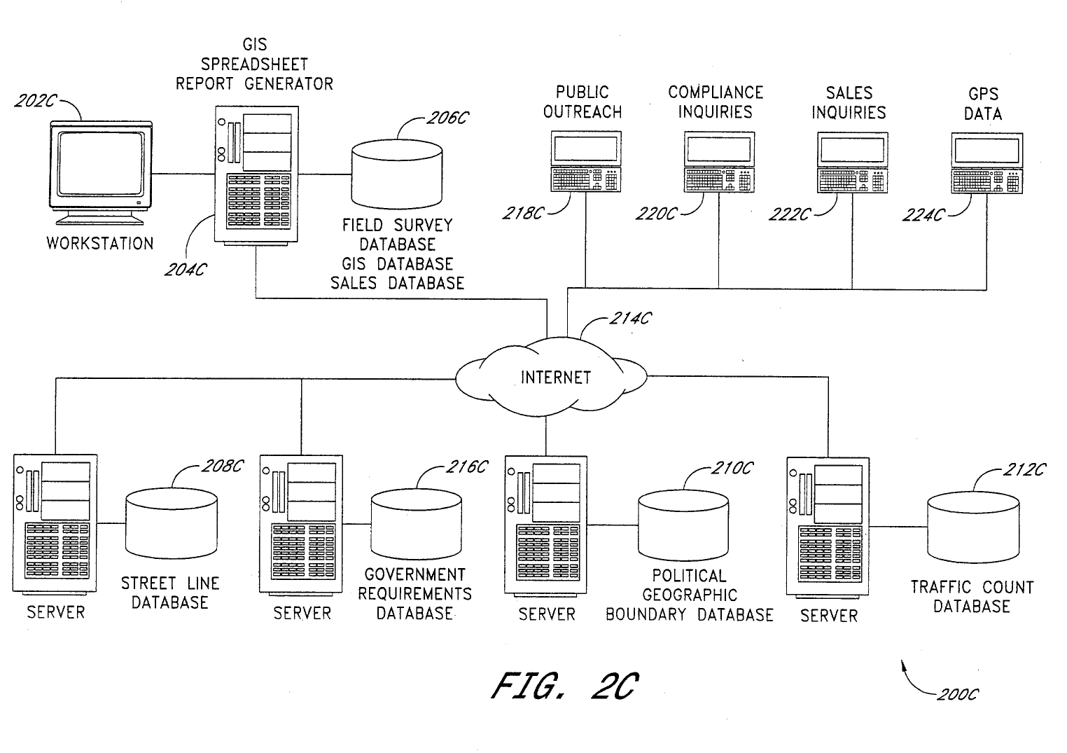

The analysis program will now be discussed with respect to the following example embodiment and FIGS. 2A and 2B. A preliminary market selection process 202A is conducted by identifying demographic metropolitan statistical areas (MSAs) based on the presence of several criteria: Businesses in the Market; Population and Outdoor Advertising; Waterway Adjacency, and the Environmental Protection Agency's region specific Waterways with the worst Total Maximum Daily Loads. Fewer or additional criteria can be used as well. Within each of these criteria several weighted factors provide data that indicate potential markets and/or the relative value of those potential markets. In one embodiment, three scales are used in weighting the raw data of these factors relative to their importance. The weighted scales fall within the example ranges of 0-5, 1-5, 0-10, 2-10, and 0-15 as below. The larger the number the greater the weighted score.

In the Businesses in the Market criterion there are three factors; Total Number of Businesses which has a weighting factor of (0-15), Total Number of Businesses with 100 or more employees (1-5), and Number of Fortune 1000 companies with the Market which has a weighting factor of (0-5). In the Population and Outdoor Advertising criterion there are two weighted factors; Total Population (2-10), which can also be limited to a subset of the total population, and Market Statistical Area ranking by the Outdoor Advertising Association of America which has a weighting factor of (0-5). In the Waterway Adjacency criterion there is one factor; Adjacency of the Demographic Metropolitan Statistical Area to Significant Regional Water Bodies which has a weighting factor of (0-10). The Environmental Protection Agency's website is a fourth criterion and consulted for its citation of region-specific Total Maximum Daily Loads (TMDLs), which may be analyzed separately from the other criteria.

TMDLs are broken down into several sub-categories as they relate to various effluents which impact the environmental quality of waterways. For example, runoff in some urban areas may be greatly affected by motor oil, while more rural areas may be affected by animal waste from feedlots. Therefore, several categories are used including, for example: pet waste, agricultural waste, human waste, pesticide overuse, litter, and/or motor oil. The statistical method of factor analysis is applied to the EPA TMDL report data to identify site-specific effluvia. This data is then queried in a Geographic Information System (GIS) to spatially identify the specific effluents as they effect the environment.

The sum of the weighted factors of the four criteria provides the ranking order of markets and order in which they will be developed.

After the preliminary market selection process is conducted, a preliminary market mapping process 204A is performed. Preliminary mapping and geographic research is conducted prior to the implementation of a program. A Geographic Information System (GIS) is used to illustrate and store geographic data relative to each market. In one example embodiment, the commercially available Environmental Systems Research Institute's (ESRI) GIS mapping software ArcView 3.2 is used, though other GIS programs can be used as well. The market mapping process 204A is illustrated in greater detail in FIG. 2B. At state 202B, the initial mapping phase street line feature data is obtained from the Geography Network website provided by Environmental Systems Research Institute (ESRI). The data is US Census 2000 TIGER line (street) shape files. This street data is obtainable at the county level by state and then is customized by each market's unique political geographic boundaries. At state 204B, the boundaries of each market are determined in the preliminary mapping phase by referencing municipal political boundaries illustrated in current-year Automobile Association of America (AAA) City Series maps.

In ArcView 3.2, market street line data is created by trimming the county street data down to the political geographic boundary of a potential market. The result of this process is a useable raw data layer that reflects the streets within a potential market area. This data layer contains useful data attributes such as; to and from addresses per line segment, street names, street types, and zip codes.

At state 206B, the street layer is amended by adding traffic count data. The traffic count data can be obtained directly from the municipalities, other local governmental bodies, or other sources. This data is temporally sensitive and is preferably standardized prior to being added to the data set. Older traffic count data is amended by multiplying the given traffic counts by the annual growth rate of the market and is compounded annually. Amended or current-year traffic count data is then added to the street layer. In the editing mode of ArcView a new numerical attribute labeled “trfc_cnts” is added to the street layer. Street names are queried, highlighted and selected from the data set. At state 208B, the traffic count for each street is added to the street layer data set. This attribute, traffic counts, is now linked to each specific street name.

The street feature is renamed as “traffic counts.” In ArcView 3.2, the street line feature layer is redrawn as a graduated symbol divided into equal intervals based on traffic count data. The result is a map that illustrates traffic count data of a potential market by line thickness where a thicker line feature indicates higher traffic counts. At state 210B, maps developed from the traffic count data are then used to identify Prime Land Value Intersections (PLVI) or potential high-traffic corridors for the implementation of a program within a market. For example, a PLVI can include areas of high commercial activity, such as malls, areas having a high density of retailers, and the like. These maps are used to develop a routing plan for the next phase in the development process, the preliminary field check.

The preliminary field check 206A can significantly increase the effectiveness of the educational material distribution. The markets are visited early in the education distribution development phase in order to identify and secure potential inventory sites. High traffic streets of potential markets are driven with the aid routing maps created from the GIS. In the field a driver notes and has recorded the presence of potential inventory locations. The locations are ranked on a scale of one to four (1-4). A ranking of four (4) would indicate that the location could feasibly support four inventory locations within a ½ mile radius of the given intersection, for example, a sign at each of four streets segments the form the intersection. Similarly, a ranking of 3, 2, or 1 respectively correspond to a location that could feasibly support 3, 2, or 1 inventory locations within a ½ mile radius of the given intersections.

In one embodiment, the market is driven in an alternate switchback pattern which often is very suitable for a city landscape. Often the use of this pattern will eliminate time wasted in the overlapping of field check sites. On average, using this switchback driving method, field researchers can cull through 15 miles square per hour. For example, the cities of Mesa and Phoenix, Ariz. were preliminarily field checked in one day resulting in the identification of 100 potential inventory sites.

A report of the preliminary field check data can then be generated at state 208A. The field data is recorded in a spreadsheet program, such as Microsoft Excel. The spreadsheet illustrates preliminary general sign locations, number of potential sign units per location area, estimated cost per sign unit, and the total revenue anticipated per year per location. In addition to the spreadsheet of the field check data, a map of potential inventory locations is created using the GIS program.

Using preliminary data from the traffic count street layer created for the preliminary field check as a base map, a new point feature layer is created and used to update the map at state 210A. The point feature layer indicates potential inventory locations identified in the field. At this state, due to the fact that the program is in a preliminary phase, the points in this layer do not have any unique attributes connected to them. Later, upon program approval unique identifier attributes are attached to the point feature layer. At state 212A both the spreadsheet of potential sign locations and maps of the potential sign locations are submitted to municipalities of potential markets for review and approval.

Next, a post-approval education distribution program development phase is implemented by converting potential inventory locations into actual inventory. Upon the approval of the program, inventory selection is conducted. A researcher returns to the preliminary inventory locations indicated on preliminary GIS maps and begins the specific light pole selection process at state 214A.

The light pole site selection process involves the identification of ideal or acceptable light poles within 100 meters of high traffic corridor intersections. The light poles are digitally photographed and stored as coded photo-inventory jpeg images. The poles are identified by type such as cement, steel or aluminum. Many municipalities label each light pole with an identification number. When present, the light pole identification number is recorded. In addition, the light poles can be tagged using an adhesive sticker or the like so that installers can later easily identify light poles to which a sign is to be affixed.

The location data of selected light poles is recorded at state 216A in one of three example site specific methods. The three methods involve the use of a Global Positioning Satellite (GPS) receiver, street address data collection for geocoding, and or descriptive data collection to create specific relative location data. These methods are used in order to create a unique identifier that will serve as a geographic locator necessary for mapping in a geographic information system (GIS).

In the first signage location process, a GPS unit is used to record the geographic location of light poles in an X, Y coordinate system. This method is relatively accurate within 30 meters but at times can be relatively inefficient due to a GPS unit's incapacity to raise an adequate satellite signal quickly. In one example, known and potential systematic errors are reduced, a standardized practice of collecting GPS data is provided to allow for repeatable results, trained technicians are used, recommendations are provided for supplying field acquired datasets used to collect feature attributes using GPS, and sponsors are supplied with terms and abbreviations common to the technology being used.

Example GPS equipment that can be used includes the Trimble GeoXT, which can acquire spatial data with sub-meter locational accuracy and can perform asset collection within a Windows CE environment. The GeoXT uses a multichannel receiver that tracks several satellites, using one channel for each satellite. The multichannel receiver is configured for identifying and filtering poor positional accuracy using multipath rejection technology. In addition, field data is captured on site for generating feature attributes in a GIS. An established field protocol ensures that the quality of spatial data is obtained with acceptable resolution.

Mission planning is conducted to determine which type of capture and processing method suits the objectives of the GIS. There are three example methods for capturing and processing GPS data including: autonomous, real-time correction, and post-processing using base station differential correction. Each of these methods produces results of varying accuracy.

With respect to GPS data acquisition, the GPS receivers are configured to:

1. Store attribute data about features collected

2. Filter poor GPS satellite reception to reduce error generation

3. Capture time and coordinates of features collected

4. Export features collected to a format that can be used by a GIS

Example GPS Receiver Settings are as follows:

Almanac acquired within 10 days

Altitude Reference Mean Sea Level (MSL) indicate Geoid Model

Antenna Height 5-7 feet

Datum WGS-84

Elevation Mask 15 degrees

Feature Type point

Logging Interval 1 second

Minimum number of positions 20-40

Mode 3D

Satellite vehicles 4

PDOP Mask 6.0 or less

SNR Mask 6.0 or greater

Unit of Measure feet

An almanac provides information for satellite acquisition in the field and for mission planning in the office. The manufacturer of Trimble GeoXT suggests almanacs are current for up to thirty days. In the field, almanacs are acquired every 12 minutes through the GPS receiver.

The antenna height used can vary depending on the specific application and field technician. The antenna height is often set at the height of the average person.

Position Dilution of Precision (PDOP) is a measure of overall error (optimum accuracy) available at time of acquisition and can be monitored by enabling a filter mask within the receiver set to collect data with a PDOP of 6.0 or less to better insure that satellite vehicles are adequately distributed.

The elevation mask filters satellite signal reception below an angle threshold from an acquired point.

The position mode setting on the GPS receiver is set to 3D. This allows positions to be collected with a minimum of four satellites. The 3D mode generates positioning for horizontal and vertical data collection.

Signal to noise ratio (SNR) refers to the overall quality of a satellite-receiver signal response.

Thus, the NGO identifies problems and solutions for implementing a spatial data dictionary and digital storage environment, develops and coordinates a product development life cycle (PDLC) for spatial data projects, recommends methods of systems storage and retrieval for spatial data projects, and provides a vehicle for community awareness programs supported by spatial data technologies.

The second signage location method includes collecting and recording street addresses of properties adjacent to the selected light poles. The collected street addresses are entered into a spreadsheet and imported into the GIS. The addresses are geocoded or matched with attributes connected to the street line feature data within the GIS. When the addresses are matched a new point feature layer is created. The new point feature layer indicates the location(s) of signage inventory.

The third signage location method involves the collection of relative location data. Light pole locations are described by their relationship to identifiable features within the landscape. For example, a light pole's relative location may read as “Lakewood Blvd near Willow St (East).” This description identifies the street on which the light pole is located, the nearest major cross street to the light pole, and the side of the street on which the pole is located.

Upon approval of the education distribution program, at state 218A preliminary GIS maps are loaded into the NGO's server-based GIS that runs on ERSI ArcSDE and ArcIMS software.

ArcSDE software facilitates the NGO's GIS to function as an integrated topological spatial database management system. Topology allows the GIS to query and manage geographic information in three-dimensional space. It can spatially illustrate what is next to what in all levels of the database. ArcSDE runs on the Oracle commercial database server.

ArcIMS (Internet Map Server) software allows the functionality of high-end geographic information system and mapping services via the Internet. The NGO's ArcIMS GIS permits users to integrate local data sources with Internet data sources for display, query, and analysis via the NGO's ArcIMS GIS Web browser. This GIS serves as an outreach and education delivery system where users access and interact with the NGO's data and Internet mapping. The data is continuously updated and connected to the existing mapping layers so that site-specific environmental messaging may be delivered. For example, the NGO can monitor the EPA or other website that provides pollution event information. If a certain pollution event occurs, such as if a toxic plume of fertilizer is reported in a water body on the EPA website, the data triggers the GIS to spatially locate the plume and it's potential geographical impact, calculate the population that will be affected in that area, and then causes a notification to the public via the web-server of the issue, and release a related best management practice notice to the population. The NGO can assess what are the best ways to distribute warning information, information on how the public can protect itself, and steps the public can take to cure the problem. For example, the foregoing information can be distributed via the NGO's signage, radio, television and/or newspaper service announcements, via the NGO's website, via handouts, printed materials and the like.

This is to say that the NGO's IMS GIS is able to generate required EPA National Pollution Discharge Elimination System NPDES reports to federal, state, regional water quality control boards and environmental advocacy groups. The GIS helps these agencies assess the effectiveness of the educational program and the municipalities and their populations it serves.

FIG. 2C illustrates an example data processing system 200C that can be used in accordance with an embodiment of the present invention. A general purpose computer or server 204C hosts the analysis, GIS, spreadsheet, and report generator application programs discussed above. The computer 204C can include a central processing unit (CPU), main memory, input/output devices, optical disk drives, and/or magnetic disk drives. A workstation 202C, including a monitor, keyboard, and optionally local memory, provides user access to the application programs. In addition, the field survey information, GIS data, and sales data is stored in one or more databases 206C. The application programs access the street line database 208C, the political geographic boundary database 210C, and the traffic count database 212C over a network 214C, which can be the Internet, and/or an intranet. Optionally, one or more of the databases 206C, 208C, 210C, 212C can be co-located, such as on the same server.

User terminals 218C, 220C, 222C, and 224 can be used to access and provide public outreach information, make compliance inquires, make and track sales inquires, and access GPS data. The user terminals 218C, 220C, 222C, and 224 can be a handheld computer, desktop PC, PDA, interactive television, a cellular phone with a browser, and/or the like. Though FIG. 2C illustrates several user terminals, the same user terminal can optionally be used to access and provide public outreach information, make compliance inquires, sales inquires, and access GPS data.

By way of example, the user terminal 218C can be used to provide online public education and outreach on storm water impacts and to provide online community forums regarding pollution to thereby increase public involvement and participation in the pollution abatement process.

The user terminal 220C can be used by government entities, sponsors, public interest groups, or the general public to track the local government body's compliance with one or more government pollution abatement regulations, such as the number of impressions of educational information made to date for the year, the types and amount of educational materials provided to the public, the water bodies that are affected by the pollution abatement, and the like. The user terminal 222C can be used to by the NGO and its sales representatives to track sales activities, the status and expiration date of existing sponsorships, and for accounting purposes. In addition, advertisers can check the status and expiration date of their existing sponsorships, the number of signs that they are sponsoring, the location of the sponsored signs, and the like. The user terminal 224C can be used to collect and review actual and/or potential sign coordinates.

In addition to facilitating the placement of educational information to better inform the general public and to enable the meeting of selected governmental requirements or goals, certain embodiments also facilitate the funding of pollution abatement, thereby helping governments comply with some or all of the EPA's six minimum control measures, and provides public education and participation at little or no expense to the governmental authority responsible for complying with the governmental requirements or goals.

For example, one embodiment provides a process that facilitates the funding of an urban and storm water runoff pollution abatement program, including and of providing educational outreach materials. The process can involve a non-profit or for-profit, non-governmental organization that manages all or portions of the funding process, and further involves governmental entities and sponsoring entities.

The non-governmental organization identifies a governmental entity, such as a local government body, which can be a state, a county, township, parish, a state governmental agency, or a municipal governmental agency, that is instructed, required or mandated to adhere to a water runoff pollution abatement program. By way of example, the water runoff pollution abatement program can limit the amount of pollution discharged into a body of water that receives water from a watershed located within the jurisdiction of the local government body. The body of water can include one or more of an estuary, bay, lake, creek, river, stream, ocean, wetland, and the like. In addition, the water runoff pollution abatement program can include a requirement to implement public educational program that informs citizens about the urban and storm water pollution problem, such as is set out in EPA's six minimum control measures.

The local government body in this example has the authority to allow the display of advertisements on, or in connection with, certain property under its control. By way of example, the local government body in this example, has the authority to allow the display of advertisements that satisfy, at least in part, the public educational program requirements, mandates, and/or goals. The property can be outdoors, adjacent to waterways, streets, highways, the sky, at arenas, or other publicly viewable locations. By way of further example, the property can be a parking meter, a light pole, a traffic pole, bus shelter, bus bench, or a parking notice. The display can be in the form of signs, banners, plaques, billboards, or skywriting, which will generally be referred to herein as “signs.” In addition, the advertisements can be provided by media other than outdoor advertising, such as radio, television, newspapers, magazines, newsletters, and web sites on a global computer network. The advertisements can also be provided via public service advertising, newsletters, educational community brochures, educational business brochures, fact sheets, children activity books, BMP guidelines, water bill inserts, Web page templates for community websites, lists of links and resources, and educational displays for special events.

Once the non-governmental organization, also referred to as an NGO, identifies the appropriate local government body, the NGO obtains permission to post educational signs intended to educate the public regarding water runoff pollution and/or to distribute or display other promotional opportunities, such as television, radio, print media, educational materials. The actual posting can be performed by the local government body using materials, information, and/or actual signs provided by the NGO. Optionally, the permission can be in the form of a permit and/or a contract. The permission can be exclusive to the NGO for a given period of time, that is, the local government body can agree not to provide another NGO similar permission to post such educational signs for a given period of time, such as a period of months or years.

In exchange for such permission, the NGO agrees to provide the local government body or its designee with non-tax funds raised by the NGO from other non-governmental entities, hereinafter referred to as “sponsoring entities,” such as companies, law firms, non-profit organizations, individuals, and the like, who want to sponsor the signs. The funds are optionally required to be used for the water runoff pollution abatement program which can include structural and/or or non-structural pollution prevention solutions, such as public educational outreach materials. The pollution abatement program and/or public educational outreach can be initiated and controlled by the local government body. Preferably, the program fosters the use by the local government body of the best management practices in abating water runoff pollution.

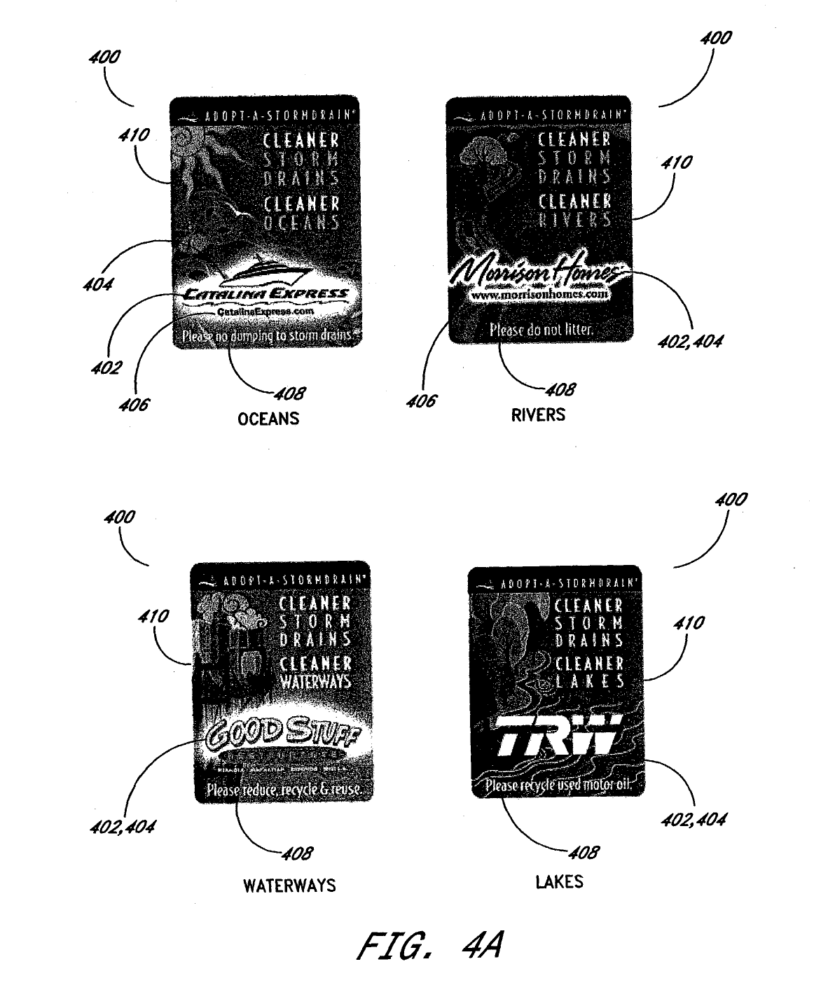

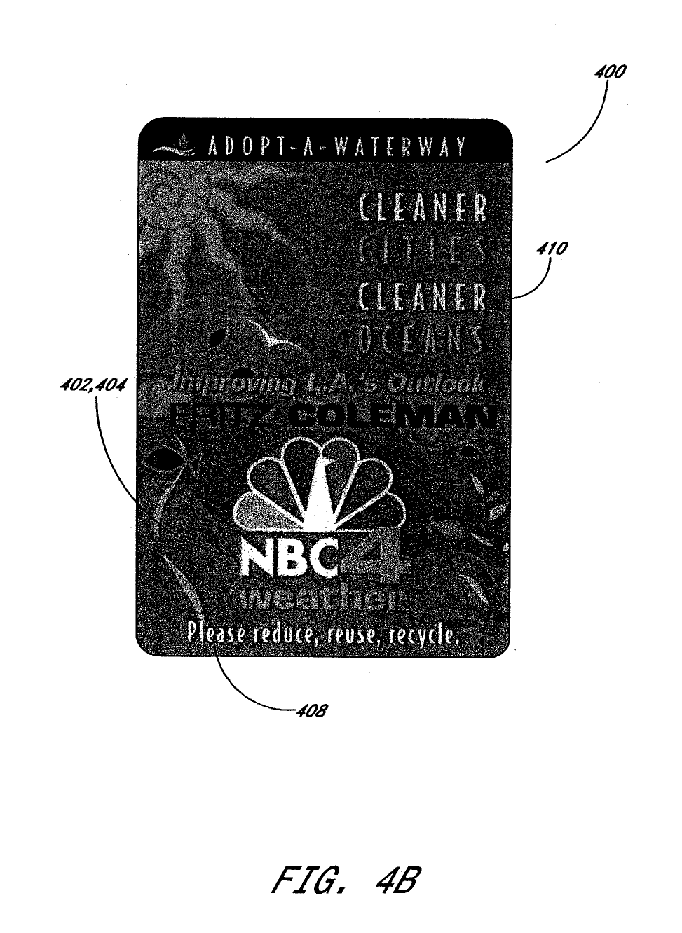

As illustrated by the example signs of FIGS. 4A-4B, a sign 400, which can be an outdoor sign, includes information, such as one or more of the name 402, the tagline (not shown), the address (not shown), the logo 404 (which can also include the name), the website address 406 and/or phone number of the sponsoring entity. In addition, the sign can indicate that sponsoring entity is a sponsor of the water runoff pollution abatement program. The information can include information 408 that educates the public on steps they can take to abate water runoff pollution, as well as memorable slogans 410 related to reducing pollution. The sign can also include a mark associated with the NGO's process. The sign can be customized for a type of body of water or a specific body of water. For example, the four signs illustrated in FIG. 4A have illustrations that respectively correspond to oceans, rivers, waterways, and lakes.

The signs can also be in the form of re-programmable electronic signs, where the message can be locally or remotely changed. The electronic sign can use LED devices, LCD displays, CRT displays, electro-luminescent displays, plasma displays, and the like.

The signage is created within a culturally sensitive context. Local iconographic images are embedded in the signage to evoke a connection between the local population and their geographic sense of place as it relates to social-environmental responsibility. That is to say, that a sign with a silhouette of a familiar local mountain range, an image of a local body of water, and/or an image of a local endangered species will evoke a connection between the viewers of the image and the local natural world.

The stylization of the objects within the signage is an incorporation of clean linear environmental elements that are easily identifiable and therefore easily read within an iconographic context. The cleanliness of the lines reflects the commonly held notion of the environment as a fully natural and pristine setting. The color palette uses warm positive hues of colors which work to create aesthetically pleasing signage that combines iconic images and environmental messages to allow the viewers to know that their actions directly impact the place on the sign that they have just made the connection with. In addition, the colors and style are selected to resonate with multiple age groups.

In one embodiment, the signage contains at least two environmental messages. The messages can be translated into the language of the local demographic in order to educate the largest audience possible per signage location.

The first environmental message is a relational message. This message provides a connection between the physical condition of cities and storm drains and the health of the local natural environment. This message is designed to help the local population make the connection between tangible objects such as their city streets or their storm drains and the health of the local water bodies which they are likely to use.

The second environmental message relates to the Best Management Practice (BMP), as mandated by the EPA. This message indicates to the public what practices or actions they take to improve the health of their environment and its adjacent water bodies. Each BMP can be tailored to meet the needs of local environmental issues. Issues such as pet waste and pathogens, litter and blight, or pesticide use and ecological impacts are illustrated in the Best Management Practice message. The BMP can be interchangeable so that the sign can also display temporal environmental issues as they occur throughout the year. Based on seasonal meteorological phenomena, various location-specific BMPs can be changed on the sign throughout the year. For example, a roadway low-salt use BMP may be necessary in the wintertime while a pesticide use BMP may be appropriate in the summertime. The change can be performed using metal or plastic inserts or adhesive panels that contain the new BMP message and that are affixed to the sign. If the sign is a programmable electronic sign, then the displayed BMP message can be similarly reprogrammed.

The use of one or more signs creates a recency effect. That is, over time the signage becomes something familiar and recognizable within the cultural landscape. It is through the recency effect, the environmental messages in the signage become a constant social reminder.

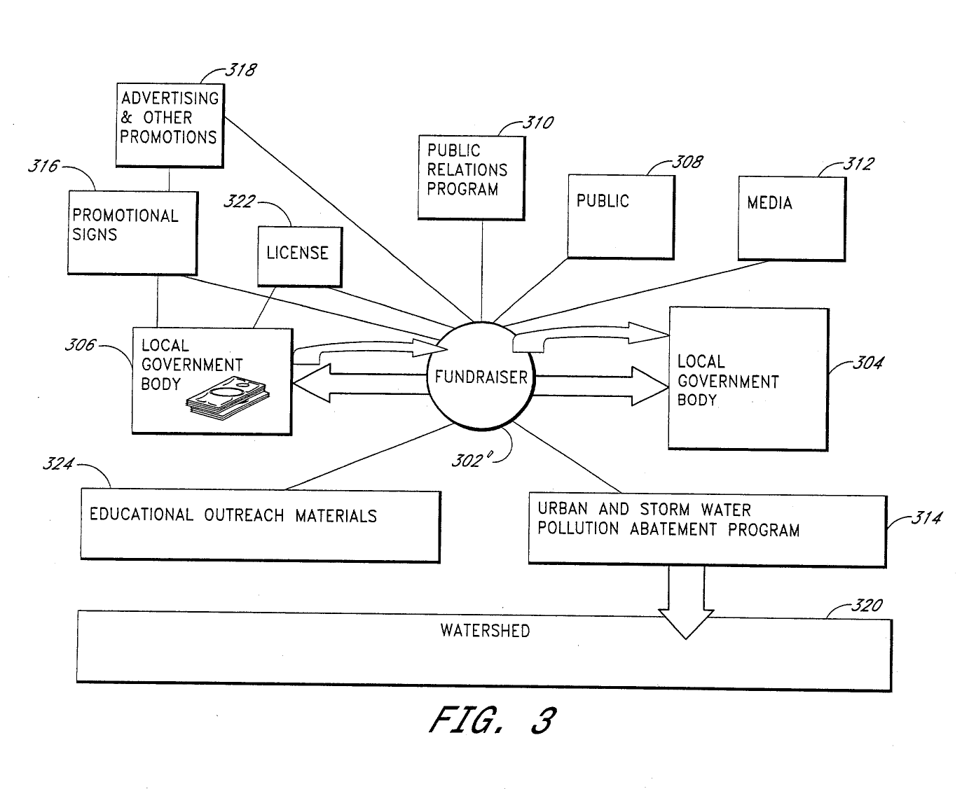

As depicted in FIG. 3, an example of the process discussed above involves interactions between the NGO 302, also referred to as a fundraiser 302, a local government body 304, a sponsor 306, and the public 308.

The fundraiser 302 reaches agreement, such as a contractual agreement, with a governmental entity, local governmental body 304, or the like to grant the fundraiser 302 permission to place, or have placed, signage for educational purposes on specific property or properties controlled by the local government body. The local governmental body can also be required to install and/or maintain the signs. In addition, the fundraiser 302 agrees to provide the local governmental body or its designee with a percentage or a predetermined amount of non-tax revenues or contributions from sponsors of the distribution of pollution-related educational information. For example, the percentage can be 50% and the revenues may be the sponsors' gross advertising revenues that are received by the fundraiser 302. The fundraiser 302 can be allowed to retain all or a portion of the remaining revenues.

Optionally, the local governmental body 304 can be required to use the funds raised only for a pollution abatement program 314, which can include the EPA's six minimum control measures such as the public distribution of educational outreach materials 324 provided by the fund raiser. The local government body 304 can also be optionally required to submit to an auditing process by the NGO to ensure funds are used only as agreed. Advantageously, complying with the pollution abatement program 314 often results in reduced pollution in the watershed 320.

The fundraiser 302 solicits funds on behalf of the local government body 304 from prospective sponsors 306. The fundraiser 302 optionally launches a public relations effort 310 that draws to the attention of media 312 the nature of the urban and storm water runoff pollution problem and regarding potential taxes that may be imposed by the local governmental body if other fund-raising measures are not adopted in a timely manner. Articles in newspapers, magazines, local government newsletters, websites, and broadcasts over the radio, television, satellite, and cable can be used to educate the population in local communities and throughout the nation of the need for pollution abatement programs 314. The sponsor 306 is linked to the pollution abatement program 314 via text, images, and the like, and to better identify the sponsor 306 as a good corporate or non-corporate citizen that contributes to the public welfare by combating a local problem and saving local taxpayers money.

In one embodiment, the fundraiser 302 collects the funds directly from the sponsor 306, and then transfers the agreed upon percentage of these funds to the local government 304. The transfer can be performed via check, or via a wire transfer or the like to a local government account. The fundraiser 302 has transparent accounting processes, which show the distribution of these funds to local government bodies 304. In another embodiment, the sponsor 306 can provide some or all of the funds directly to the local government via check, wire transfer to a local government account, and the like. In this case, the sponsor 306 can also provide the fundraiser 302 with an agreed upon payment, or the local government 304 can pay the fundraiser using a portions of the non-tax funds from the fundraiser 302.

In one embodiment, the fundraiser 302 optionally does not use the funds collected to directly implement the pollution abatement program 314. Rather, it is the local government body 304 that creates and implements the program 314 under its control and direction. Depending on the specific agreement between the fundraiser 302 and the local government body 304, the fundraiser 302 may provide educational outreach materials 324 at no charge to the local government 304, in addition to funds for the local government's pollution abatement program 314 received from sponsors 306. The local government 304 may use part of the funds from the fundraiser 302 for educational outreach materials 324 or receive these materials from the fundraiser 302 in addition to the funding.

Outreach programs can be tailored to address the viewpoints and concerns of different communities, including minority and disadvantaged communities, as well as special concerns relating to children so as to comply with the abatement program. The outreach materials can include one or more of public service advertising, newsletters, educational community brochures, educational business brochures, fact sheets, children activity books, BMP guidelines, water bill inserts, Web page templates for community websites, lists of links and resources, and educational displays for special events.

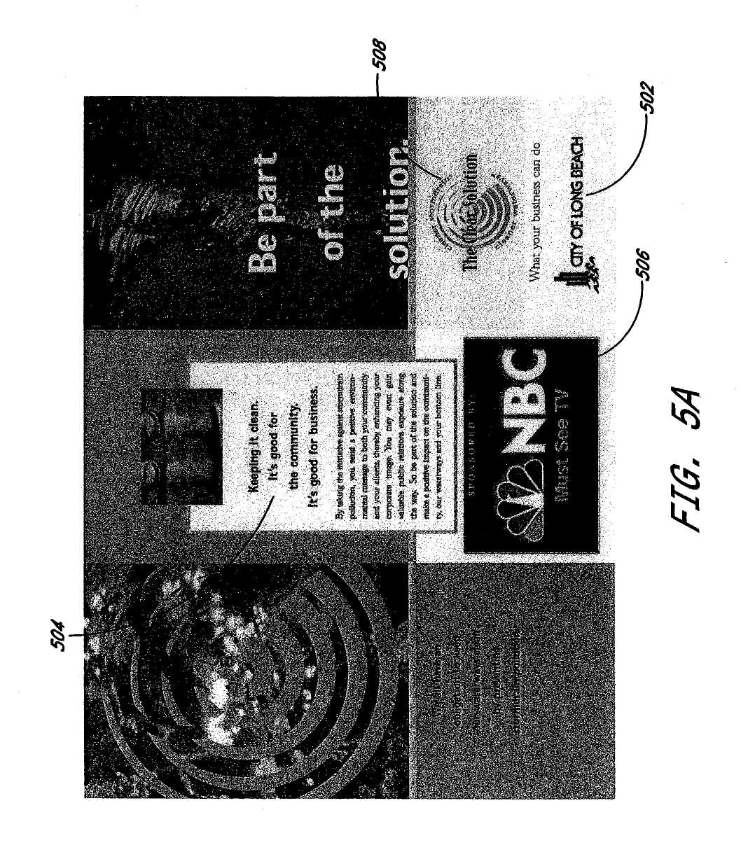

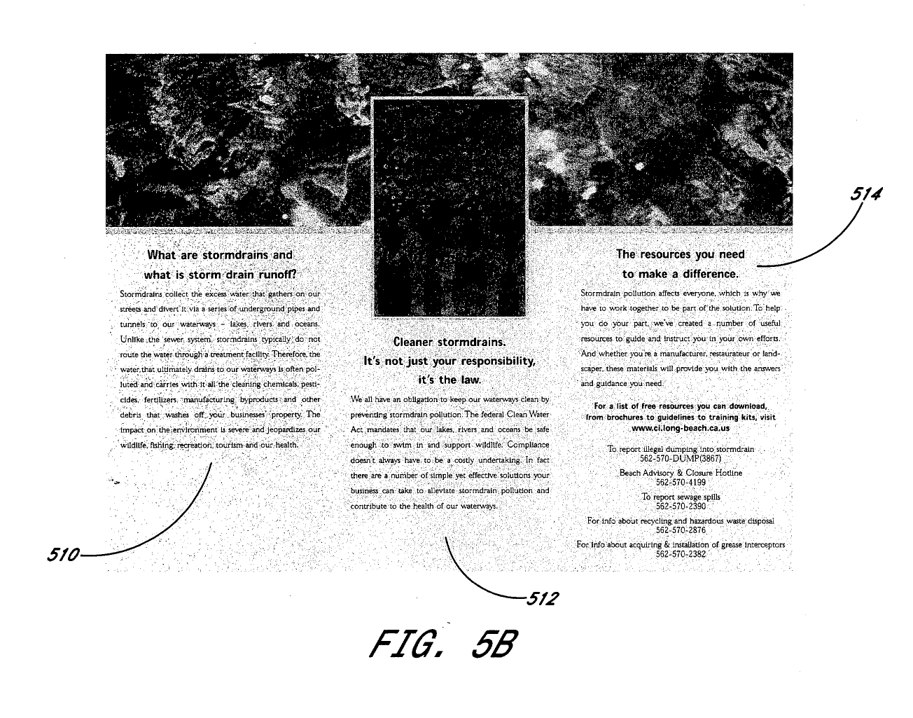

For example, an outreach brochure, as illustrated in FIGS. 5A-5B, can include the name of the city or local community 502 in which the brochure is being distributed, information on the benefits the local community can reap as a result of pollution reduction 504, summaries of laws and regulations relating to pollution 512, an explanation on storm drains and storm drain runoff 510, and resource information 514. The resource information 514 can include, for example, contact information for pollution-related contacts. For example, the contacts can be for reporting illegal dumping into a storm drain, for beach advisory and closure information, for reporting sewage spills, for recycling information, for hazardous waste disposal, and for the acquisition and installation of pollution prevention devices, such as grease interceptors. The contact information can include phone numbers, web addresses, and/or physical addresses.

In addition, the brochure can include sponsor information 506. The sponsor information 506 can include the name, the tagline, the address, the logo, and the website address and/or phone number of the sponsoring entity. The brochure can also include the mark and/or taglines 508 associated with the NGO's process. The brochure can be customized for a type of body of water or a specific body of water.

The public relations effort 310 induces the media 312 to publish or broadcast news or articles in support of the program 314, helping to educate the general public 308 regarding water pollution and its adverse affects. The public relations effort 310 also creates recognition among prospective sponsors of the program 314 and the desirability of being a sponsor.

The sponsors 306 can be motivated to participate with the fund-raiser 302 in return for the right to display advertisements or receive promotional opportunities linking them to the funding of the program 314. These advertisements may be promotional signs 316 on property under the jurisdiction of the local government 304 under its administration or other types of advertising 318 disseminated in other ways. The promotional opportunities can also include receiving recognition for funding educational outreach materials 324 created by the fundraiser 302, which link the sponsor 306 to the funding of the program 314.

The promotional signs 316 are not limited to display along roadways, but, as authorized, can be displayed on any appropriate property owned or controlled by the local government 304, such as bus shelters and bus benches. These advertisements or promotional opportunities 316 can be signage on curbsides, on parking meters, on crossing-signals, on existing light poles, at parks and beaches, or banners or indoor signage in municipal office buildings at counters, desks, on websites controlled by the local governments 304.

The promotional signs 316 display a mark. The mark can be service mark or a trademark, for example, Adopt-A-Stormdrain or Adopt-A-Waterway, which are the marks of Adopt-A-Stormdrain L.L.C. The mark can be followed by the name and, in some cases, the logo, tagline, address, website information, or phone number of an individual sponsor 306. The mark signifies that the sponsor 306 is a contributor to the program 314. Many different sponsors 306 could be simultaneously displaying signs 316 and advertising 318 linking them to the program 314. The signs facilitate the education of citizens within the jurisdiction of the local government on what they can do to abate pollution of the nation's waterways.

In design and in message, the signs are educational and reflect the geographic area and the body of water in the area where they are to be installed. For example, signs near the ocean would feature illustrations of oceans and the message would read: “Cleaner Storm Drains, Cleaner Oceans.” Other example phrases that can be used include “Cleaner Cities, Cleaner Environment, “Cleaner Cities, Cleaner Water” and the like. Including educational messages on the outdoor advertising signs help people understand how their actions affect the pollution problem. Messages, such as “Please do not litter” or “Please no dumping in the storm drain,” also meet part of the community education requirements under the federal NPDES permit rules that local governments must follow. The messages on the signs can be rotated so they better fit a particular time of year or fill an important or critical community need. The signs are tailored to suit the community's culture and are written in the language spoken by people who live in the community, as discussed above.

The fund-raiser 302 can run advertising 318 promoting funding of the program 314, and in some cases, linking the sponsor 306 to the program. Through a license 322, the sponsor can be licensed to use the mark to its advantage. A licensed sponsor 306 will be identified with the program 314 and can be permitted to use the mark on its stationary, business cards, vehicles, or any other advertisement of the sponsor approved by fundraiser 302. Such a licensing strategy enables the mark gain public recognition and enhances the sponsor's image as a good citizen who directly supports the program for the public's benefit. Consequently, the present invention is not limited to the display of signage in a limited geographical area. Rather, in one embodiment, through licensing of the mark, the fundraiser 302 increases the value and recognition of both the mark and the benefits to the sponsor 306, the local government body 304, and the public 308.

The fundraiser 302 can be the owner of the mark or the mark can be licensed by a national or other organization that owns the mark and is responsible for nationwide fund-raising operations. Preferably, the mark is registered with the federal government. Through a focused public relations effort 310, prospective sponsors will recognize the strong community relations value by visibly supporting the program 314 through such promotional opportunities as promotional signs 316 and other advertising 318 or licensed used of the mark.

The fundraiser 302 approaches prospective sponsors through its marketing representatives. This increases the likelihood of sponsor participation and the visibility for sponsors 306. Through on-going promotional activities by means of the public relations effort 310, prospective funding sources recognize the mark as the source responsible for raising funds for the water runoff pollution abatement program 314 administered by local government bodies and employing best management practices.

The funds raised thereby can, for example, be used at least in part to fund other aspects of a runoff pollution abatement program. For example the funds can be used to fund one or more of the following examples:

hiring knowledgeable consultants to develop structural and non-structural strategies to reduce urban and storm water runoff;

catch basin control to prevent entry of solid trash, oil, and other pollutants to storm drains;

watershed and storm drain cleaning prior to the rainy season;

hiring grant-writing experts to tap into public and private grants for funding and research to abate pollution resulting from runoff;

educational outreach and public awareness campaigns to citizens within the local government body's jurisdiction to educate people on how their actions affect the problem;

filtering, catch basin inserts, and other pollution control technologies;

dry flow and low flow diversion projects to divert urban runoff during dry weather for treatment prior to discharge into waterways; and/or

collaborative efforts with other organizations whose efforts focus on preservation of waterways.

Thus, as described above, embodiments of the present invention facilitate the provisioning of educational materials while also facilitating the funding of the same, thereby helping governments comply with some or all of the EPA's six minimum control measures. Further, certain embodiments facilitate the auditing of participating governmental entities to better ensure the funds and educational materials are used for an urban and storm water runoff abatement program. Outreach programs can be tailored to address the viewpoints and concerns of different communities, including minority and disadvantaged communities, as well as special concerns relating to children so as to comply with the abatement program.

In addition, certain embodiments enable local businesses and national corporations to benefit from advertising and promotional opportunities in their communities of interest as sponsors of efforts to abate pollution. Embodiments facilitate the designing, installing, and maintaining an inventory of beneficial outdoor and roadside advertising signs created through the sponsorship of specific local government bodies' urban and storm water runoff abatement programs. Advantageously, certain embodiments help local and other governments avoid fines and other penalties for failure to meet NPDES permit requirements

It should be understood that certain variations and modifications of this invention would suggest themselves to one of ordinary skill in the art. The scope of the present invention is not to be limited by the illustrations or the foregoing descriptions thereof.

What is claimed is:

1. A method of distributing pollution related information by a first non-governmental entity, comprising:
identifying a local government body that is to adhere to a water runoff pollution abatement program, including a pollution-related public educational element, wherein the local government body has the authority to allow the display of an advertisement on at least a portion of property under its control;
obtaining funding from a second non-governmental entity for at least a portion of the water runoff pollution abatement program;
receiving authorization from the local governmental body for the first non-governmental entity to provide at least a first advertisement containing both pollution-related educational information and identification information corresponding to the second non-governmental entity on at least a first property under local governmental body's control; and
providing at least a portion of the funding to the local government body to be utilized in connection with implementation of the water runoff pollution abatement program under the control of the local governmental body.

2. The method as defined in claim 1, wherein the local government body is required by the EPA's Six Minimum Control Measures to implement a public educational program informing citizens about storm water pollution problem and prevention.

3. The method as defined in claim 1, further comprising estimating how many impressions will be made within a first time period for at least the first advertisement.

4. The method as defined in claim 1, further comprising comparing an estimated number of impressions for at least a first advertisement with a number specified by a government entity.

5. The method as defined in claim 1, further comprising receiving authorization from the local governmental body to provide advertisements using at least one of television, radio, print media, and educational literature.

6. The method as defined in claim 1, wherein the first advertisement is an outdoor sign and the identification information for the second non-governmental entity includes one or more of a name, a tagline, an address, a logo, a website address and a phone number.

7. The method as defined in claim 1, wherein the first advertisement indicates that the second non-governmental entity is a sponsor of the water runoff pollution abatement program.

8. The method as defined in claim 1, wherein the local government body is one of a state, a county, township, parish, a state governmental agency, and a municipal governmental agency.

9. The method according to claim 1, wherein the first property is located outdoors.

10. The method according to claim 1, wherein the first property includes at least one of a parking meter, a light pole, a traffic pole, a parking notice, bus shelter, bus bench, and an arena.

11. The method according to claim 1, wherein the first advertisement includes at least one of a banner, a sign, a plaque, a billboard, and skywriting.

12. The method according to claim 1, wherein the funding does not include tax revenues.

13. The method according to claim 1, wherein the water runoff pollution abatement program includes structural pollution prevention.

14. A method of distributing pollution related information, comprising:
obtaining non-tax funding from a non-governmental entity for at least a portion of a water runoff pollution abatement program;
receiving authorization from a local governmental body for the display of at least a first advertisement related to the water runoff pollution abatement program on at least a first property; and
providing at least a portion of the funding to the local government body for implementation of the water runoff pollution abatement program, wherein the water runoff pollution abatement program is at least partly under the control of the local governmental body.

15. The method as defined in claim 14, further comprising identifying the local government body as one that is required to adhere to the water runoff pollution abatement program, the water runoff pollution abatement program including a public educational element.

16. The method as defined in claim 14, wherein the first advertisement includes educational information.

17. The method as defined in claim 14, wherein the pollution abatement program includes a requirement to educate people regarding abatement of water runoff pollution.

18. The method as defined in claim 14, wherein the water runoff pollution abatement program fosters the use by the local government body of the EPA's Best Management Practices in abating water runoff pollution.

19. The method as defined in claim 14, further comprising providing a sign configuration illustrating at least one of a local mountain range, an image of a local body of water, and an image of a local endangered species.

20. The method as defined in claim 14, wherein the first property includes at least one of a parking meter, a light pole, a traffic pole, a parking notice, and an arena.

21. The method as defined in claim 14, wherein the first advertisement is to be provided using a plurality of media, including at least one of radio, television, newspaper, magazine, newsletter, and a website.

22. The method as defined in claim 14, wherein the local government body receives a percentage of the funding from a fundraiser for said pollution abatement program.

23. The method as defined in claim 14, further comprising providing an information brochure, wherein the information includes:
a name of at least a first governmental entity in which the brochure is being provided;
a summary of at least a first law relating to pollution;
information on storm drain runoff; and
resource information.

24. The method as defined in claim 14, wherein the local government body is required to use the funds for one or more of:
hiring consultants to develop strategies to reduce storm water runoff;
catch basin control to impede entry of pollutants into storm drains;
storm drain cleaning;
filtering;
storm drain inserts;
hiring grant-writing experts;
pollution-related public awareness programs;
a diversion project to divert runoff during dry weather for treatment prior to discharge into waterways; and
collaborative efforts with other entities.

25. The method as defined in claim 14, further comprising adopting a mark indicating that the water runoff pollution abatement program is being conducted and licensing this mark to the non-governmental entity to signify that the non-governmental entity is supporting the program.

26. A method of distributing pollution related information, comprising:
identifying a governmental entity subject to a pollution reduction program;
obtaining voluntary funding from a non-governmental sponsor for at least a portion of the pollution reduction program;
arranging with the governmental entity for the display of at least a first advertisement on at least a first property under at least partial control of the governmental entity, the first advertisement related to the pollution reduction program; and
arranging for at least a portion of the funding to be provided to the local government body for implementation of the pollution reduction program under the control of the governmental entity.

27. The method as defined in claim 26, further comprising comparing an estimated number of impressions for at least a first advertisement with a number of impressions specified by a government entity.

28. The method as defined in claim 26, wherein a non-governmental agency solicits the funding from the non-governmental sponsor.

29. The method as defined in claim 26, wherein the pollution reduction program is a water pollution reduction program.

30. The method as defined in claim 26, wherein the pollution reduction program is an air pollution reduction program.

31. The method as defined in claim 26, wherein the first advertisement is a sign including at least one of a name, a tagline, an address, a logo, a website address and a phone number of the sponsor.

32. The method as defined in claim 26, wherein the funding does not include tax revenues.

33. The method as defined in claim 26, further comprising performing a market selection process, the market selection process based at least in part on a quantity of businesses of at least a first type in a first market, a size of at least of at least a subset of the first market population, and the first market's adjacency to a waterway.

34. The method as defined in claim 26, further comprising performing a market selection process, the market selection process based at least in part on a quantity of businesses of at least a first type in a first market, a size of at least of at least a subset of the first market population, and the first markets adjacency to a waterway, and Environmental Protection Agency information related to a pollution level for at least a first waterway.

35. The method as defined in claim 34, further comprising mapping at least a portion of the first market, performing a market field check, and ranking potential inventory sites.

36. The method as defined in claim 26, further comprising obtaining street line data, geographic boundary data, and traffic count information for a first map of at least a portion of a geographic area under control of the governmental entity.

37. The method as defined in claim 26, further comprising providing at least one of a newsletter, an educational community brochure, an educational business brochure, a fact sheet, a children activity book, a BMP guideline, a water bill insert, a pollution abatement education Web page template for a community website, a list of pollution-related links and resources, and an event specific educational display.

38. A sign, comprising:
an image of at least one body of water;
one or more of a sign sponsor name and logo; and
information on water pollution abatement.

39. The sign as defined in claim 38, wherein the information on water pollution includes a relational message that provides a connection between a physical condition of at least one of a city and a storm drain, and a local natural environment.

40. The sign as defined in claim 38, wherein the information on water pollution includes a message that relates to the Best Management Practice as defined by the EPA.

41. The sign as defined in claim 38, wherein the information on water pollution is changeable.

42. The sign as defined in claim 38, wherein the sign is electronically re-programmable to display seasonal environment messages.

43. The sign as defined in claim 38, further comprising at least one of a parking meter, a light pole, a traffic pole, and a parking notice.

44. The sign as defined in claim 38, further comprising an icon image related to the water pollution abatement message.

45. The sign as defined in claim 38, wherein the sign is paid for using non-tax revenues.
